(19) United States
(12) Patent Application Publication
(10) Pub. No.: US 2026/0212354 A1
(43) Pub. Date: Jul. 23, 2026

(54) A SYSTEM AND METHOD OF PERFORMING A TRANSACTION THROUGH A CREDIT ACCOUNT USING BLOCKCHAIN

(71) Applicant: Venusai CHODISETTI, Bangalore (IN)

(72) Inventor: Venusai CHODISETTI, Bangalore (IN)

(21) Appl. No.: 19/145,933

(22) PCT Filed: Jan. 9, 2024
(86) PCT No.: PCT/IB2024/050209

§ 371 Date: Jul. 5, 2025

(30) Foreign Application Priority Data
Jan. 9, 2023 (IN) 202341001499

(51) Int. Cl. G06Q 20/40; G06Q 20/38

(52) U.S. Cl. CPC G06Q 20/401; G06Q 20/389

(57) ABSTRACT

The present disclosure provides a system and method of performing a credit transaction using blockchain. The method includes the steps of: verifying (401) details of a user for registering a user profile on a payment interface, by a processor of a server, then creating (402) a credit account on the payment interface for the user profile, by linking to a debit account of the user, by a processor of a user device. Then, a unique code is generated (403) corresponding to the user profile based on government authorised document data and biometrics data, for facilitating transactions on the payment interface, by the user device. Then, initiating (404) a transaction involving an amount, between a unique code of a payer and a payee, transferring (405) the amount from the payer to the payee, wherein the amount transferred (406) to credit account by the processor of the server.

### FIELD

The embodiments herein generally relate to a transaction involving credit account using blockchain. More particularly, the disclosure relates to a system and method for performing a transaction through a credit account using blockchain.

### BACKGROUND AND PRIOR ART

Net banking, debit cards and credit cards, are few of the widely used cash less modes of transactions utilized commonly all over the world. These modes of transactions require technological support for processing cash-less payments between different entities.

However, among the given modes, transaction involving credit cards involves large amount of fee for processing the transaction. Further, in circumstances involving transferring an amount between entities in different countries, credit card based transactions are deemed expensive due to huge fees. Yet, credit account based transaction offer an edge over other modes, as they provide convenience to the user and enable ease of access for cross-currency transactions.

Furthermore, with increasing demand for cross-country and cross-currency based transactions, there is a lack of technical applications providing faster transactions and feasible transaction fees in credit account based transfers.

Therefore, there is a need for facilitating faster and a cost-effective credit account based transaction between entities irrespective of currency and country. Moreover, there is a need for a secured and improved system and method for facilitating a card less credit account based transaction.

### OBJECTS

Some of the objects of the present disclosure are described herein below:
The main objective of the present disclosure is to provide a system and method of performing a transaction through a credit account using blockchain.

Another objective of the present disclosure is to provide a system and method of performing a card less transaction using blockchain.

Still another objective of the present disclosure is to provide a system and method of a secured system and method of performing a card less transaction using blockchain.

Yet another objective of the present disclosure is to provide a faster and economical system and method of performing a transaction using blockchain.

Another objective of the present disclosure is to provide a system and method of performing a cross-country and cross-currency transaction through a credit account using blockchain.

Still another objective of the present disclosure is to provide a system and method of a secured system and method of performing a transaction through a credit account using blockchain.

Yet another objective of the present disclosure is to provide a faster and economical system and method of performing a transaction through a credit account using blockchain.

The other objectives and advantages of the present disclosure will be apparent from the following description when read in conjunction with the accompanying drawings, which are incorporated for illustration of preferred embodiments of the present disclosure and are not intended to limit the scope thereof.

### SUMMARY

In view of the foregoing, an embodiment herein provides a system and method of performing a transaction through a credit account using blockchain.

In accordance with an embodiment, the system includes but not limited to a plurality of payers devices, a plurality of payee devices, a server and a communication network. In an embodiment, the user including the payer and/or the payee accesses the user device including the payer device and/or the payee device. The payer accesses a user interface in the user device for transferring an amount from a credit account to the payee, using blockchain for facilitating faster and cost-effective transfers irrespective of country and currency.

In an embodiment, the plurality of payer devices and the plurality of payee devices are connected to the server through the communication network.

In accordance with an embodiment, the system for performing a transaction on a blockchain, comprising a user device including a processor and a memory, a server including a processor and a memory. The user device is connected to the server through a communication network. The processor of the user device is configured to: transmit user data to the server through a payment interface to initiate a request for registration of a user, initiate a transaction of an amount to a payee account through the payment interface. The processor of the server is configured to connect to a blockchain network of an entity transaction engine, link a bank account in an issuing bank to an entity bank on the entity transaction engine based on the request of registration of the user, generate a unique code for the user based on the user data and the bank account for performing the transaction to the payee account through the entity transaction engine.

In an embodiment, a point-of-sale terminal device is connected to the entity transaction engine, wherein the point-of-sale device registered with a payee account, and wherein the point of sale terminal device connecting to the entity transaction engine on receiving the unique code from the user device or entity transaction engine, for transferring the amount from the bank account to the payee account.

In an embodiment, the processor of the server is configured to: connect to the bank account associated with the unique code through the processor of the server, record a block of the transaction on the blockchain network of the entity transaction engine on verification of identifiers of the transaction, generate a first SmartContract on the blockchain network based on the identifiers of the transaction to be transmitted to an entity bank, generate a second SmartContract on the blockchain network based on the identifiers of the transaction transmitted to an issuing bank associated with a bank account of the user, and verify the transaction based on the first SmartContract and the second SmartContract by a consensus mechanism on the blockchain network for performing the transaction between the bank account and the payee account.

In accordance with an embodiment, the method includes the following steps. First, verifying details of a user for registering a user profile on a payment interface, by a processor of a server. Then, creating a credit account on the payment interface for the user profile, by linking to a debit account of the user, by a processor of a user device. Next, generating a unique code corresponding to the user profile based on government authorised document data and biometrics data of the user, for facilitating transactions on the payment interface, by the processor of the user device. Next, generating a unique code corresponding to the user profile, for facilitating transactions on the payment interface, by the processor of the user device. Finally, transferring the amount of the transaction from the payer to the payee, by the processor of the server.

In accordance with an embodiment, the method of performing a transaction using blockchain, comprises the following steps. First, registering a user in an entity transaction engine on a blockchain network on verifying user data received from a user device, by a server. The registering includes the steps of linking a bank account in an issuing bank to an entity bank on the blockchain network, generating a unique code combining the user data and the bank account, by a processor of a user device, and storing the unique code corresponding to the user in a database on the blockchain network, by the server. Then, initiating a request for transaction for transferring an amount from the bank account to a payee account using the unique code, by the processor of the user device. Finally, connecting to the bank account through the unique code for transferring the amount to the payee account through the blockchain network, by the server.

In an embodiment, transferring the amount can include verifying identifiers of the transaction including the unique code, amount, bank account and payee account, by the server using the blockchain database, recording the transaction on a block on the blockchain network after verification, by the server, generating a first SmartContract defined using one or more identifiers of the transaction to be transmitted to the entity bank, by the server, connecting to a issuing bank associated with the bank account of the user based on the identifiers of the transaction, by the processor of the user device and POS device or entity transaction engine, generating a second SmartContract defined using the one or more identifiers of the transaction transmitted to the issuing bank, by the server, verifying the transaction by comparing the first SmartContract and the second SmartContract for matching the identifiers by a consensus mechanism, and transmitting the amount received from the issuing bank to the payee account for performing the transaction.

In an embodiment, wherein the bank account of the user is a credit account in the issuing bank.

In an embodiment, the user data can include but not limited to user name, bank account of the user, government authorized documents and contact data including phone number, email Id, address, and wherein the verifying including connecting to an external application through API for verifying the government authorized documents and the bank account provided in the user data corresponding to the user.

In an embodiment, the method can include registering a point-of-sale terminal device to the entity transaction engine, wherein the registering can include storing the point-of-sale terminal device parameters including a payee account and an ID associated with the point-of-sale device on the entity transaction engine, receiving the unique code from the user device for performing the transaction to the payee account, and connecting to the entity transaction engine for transferring the amount from the bank account to the payee account.

In an embodiment, the point-of-sale terminal device can include a face scanner for verifying the user to initiate the transaction, wherein the face scanning data stored in the user data in the entity transaction engine received from the user during the registration.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a block diagram of a user device of a system of performing a transaction through a credit account using blockchain, according to an embodiment herein;

FIG. 2 illustrates a block diagram of a server of a system of performing a transaction through a credit account using blockchain, according to an embodiment herein;

FIG. 3 illustrates a block diagram of the system of performing a transaction through a credit account using blockchain, according to an embodiment herein;

FIG. 4 illustrates a flow chart of a method of performing a transaction through a credit account using blockchain, according to an embodiment herein;

FIG. 5 illustrates a flowchart of performing a transaction on blockchain, according to an exemplary embodiment; and

FIG. 6 illustrates a flowchart of performing a cross-currency transaction on blockchain, according to an exemplary embodiment.

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

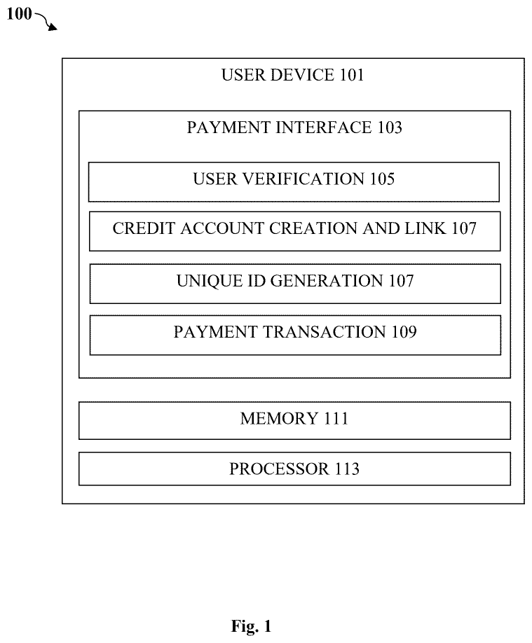

As mentioned above, there is a need for facilitating faster and a cost-effective credit account based transaction between entities irrespective of currency and country. In particular, there is a need for a secured and improved system and method for facilitating a card less credit account based transaction. The embodiments herein achieve this by providing “A system and method of performing a credit transaction using blockchain”. Referring now to the drawings, and more particularly to FIG. 1 through FIG. 4, where similar reference characters denote corresponding features consistently throughout the figures, there are shown preferred embodiments.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art.

The systems described herein, may be realized by hardware elements, software elements and/or combinations thereof. For example, the devices and components illustrated in the example embodiments of inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

Blockchain is a technology for storing data. The data in a blockchain is stored in a plurality of blocks, wherein the blocks are linked to each other. A blockchain network is a network of a plurality of communication devices including a computer or laptop or a mobile phone. Each communication device is a node, wherein the plurality of nodes is connected to each other through internet. The nodes broadcast information, relay information and store the information in a new block in a blockchain for ensuring immutability and transparency of data.

FIG. 1 illustrates a block diagram of a system of performing a transaction through a credit account using blockchain. In an embodiment, the user device 101 is accessed by a payer and/or a payee for performing the transaction. The user device 101 includes a memory 111 and a processor 113. The memory 111 in the user device 101 can be configured for storing instructions for performing the transactions. The processor 111 in the user device 101 can be configured for executing the stored instructions for performing the transaction.

The user accesses a payment interface 103 using the user device 101 for performing the transaction.

In an embodiment, the user verification 105 can be configured in the payment interface 103 for verifying the user. The user verification 105 includes submitting user details, by the user using the payment interface 103, wherein the user details can include but not limited to name, phone number, address, government authorized document data and biometric data. Government authorized document data includes number of the government authorized document. The government authorized document can include but not limited to Aadhaar, and PAN. In an embodiment, the biometric data can include but not limited fingerprint data, iris data, face data. Then, the user verification 105 can be configured for verifying the user details by connecting to an external database corresponding to the government authorized document using API. The user verification 105 compares the user details received from the user with details extracted from the government authorized document. On verifying the details, the user verification 105 provides access to the user for creating a credit account and using the payment interface 103 for performing transactions. The user verification 105 generates a user profile for the user after successful verification, wherein the successful verification refers to verified user details.

In an embodiment, the credit account creation and link 107 is provided for creating a credit account corresponding to the user. The credit account creation 107 includes receiving details of at least one bank account (debit account) of the user and linking the credit bank account to the payment interface 103. In an embodiment, when the user includes a credit bank account, the credit account creation and link 107 facilitates linking the existing credit bank account to the payment interface 103.

In an embodiment, on creating the wallet, the unique code generation can be configured for generating a unique code for the user profile connected to the credit account. In an embodiment, the unique code is generated based on the government authorized document data and biometrics data of the user. The unique code is linked to the credit account, wallet, and bank(debit) accounts associated with the user profile.

In an embodiment, a payment transaction 109 is provided for facilitating the user to perform a transaction by transferring an amount to another user.

In an embodiment, the unique code is configured for debiting and transferring a value from the wallet, bank account and/or crypto-wallet associated with the user profile, wherein the unique code is represented in a form including but not limited to a number, a QR code. In an embodiment, the unique code links the credit account of the user to blockchain for performing the transaction.

In an embodiment, the unique code is linked to a bank account in plurality of countries for facilitating cross-country transfer of currency without conversion.

In an embodiment, the value can include one of fiat currency and digital currency.

In an embodiment, the payment interface 103 is accessed by the user by submitting two-factor authentication. Two-factor authentication is based on a first factor including the unique code and a second factor including but not limited to one-Time Password (OTP), biometric data.

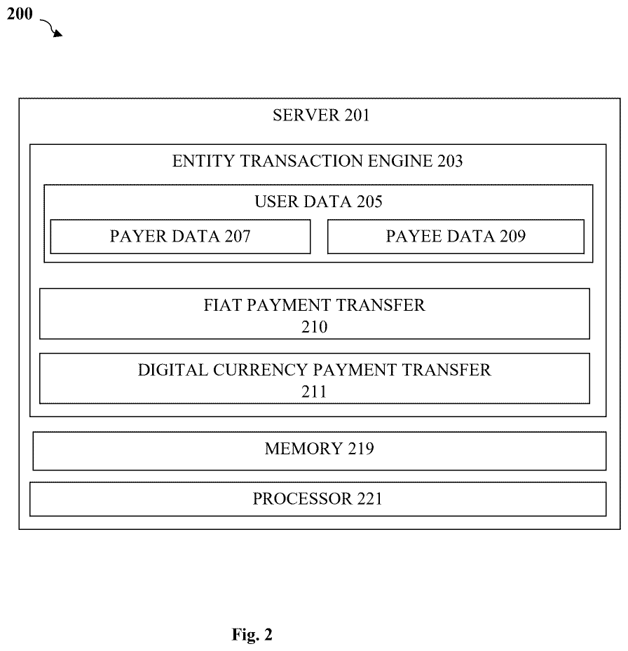

FIG. 2 illustrates a block diagram of a server of a system of performing a transaction through a credit account using blockchain. In an embodiment, the payment interface 103 is connected to the server 201 for performing the transaction between the users. In an embodiment, the server 201 can include but not limited to a transaction engine 203, a processor 221 and a memory 219. In an embodiment, the memory 219 can be configured for storing instructions for performing the transaction between the users. In an embodiment, the processor 221 can be configured for executing the stored instructions for performing the transaction between the users.

In an embodiment, the transaction engine 203 is configured for performing the transaction from the payer to the payee. The transaction engine 203 includes a user data 205, a fiat payment transfer 210, a digital currency payment transfer 211.

In an embodiment, the user data 205 can include a payer data 207 and a payee data 209. The payer data 207 can be configured for receiving details of user profiles performing the transaction. In an embodiment, the payee data 209 can be configured for receiving details of user profiles performing the transaction. In an embodiment, the server 201 is connected to a database, wherein the user data 205 including the payer data and the payee data 209 is transmitted to the database for storing the user data corresponding to each transaction.

In an embodiment, the server monitors statistics of income and expense behavior of the user (payer/payee) for creating the credit account from the payer data and payee data, wherein the server facilitates creation of the credit account on determining income greater than expense and does not facilitate creation of the credit account on determining income less than expense.

In an embodiment, the unique code associated with the credit account of the payer is linked to a credit account in local banks in plurality of countries for facilitating cross-country transfer of currency without conversion.

In an embodiment, the fiat payment transfer 210 is configured for transferring the amount for the transaction based on a country of the payer and country of the payee. In an embodiment, the fiat payment transfer 210 is configured for identifying a country of the payer from the payer data and a country of the payee from the payee data. The fiat payment transfer 210 determines the credit account of the payer in the local bank in the country of the payee. A contract is created in the blockchain corresponding to the transaction including the amount of transaction and details of payer and payee. Then, the fiat payment transfer 210 transfers the amount for the transaction from the credit account in the payee country linked with the unique code of the payer, to the account of the payee, thereby eliminating conversion of currency and transaction fees due to utilization of cards.

In an embodiment, the digital currency payment transfer 211 is configured for transferring the amount for the transaction through blockchain. In an embodiment, the amount is transferred through blockchain when the credit account of the payer is not provided in the country of the payee and/or when the payer prefers transmitting digital currency tokens. The digital currency payment transfer 211 is configured for transmitting a notification corresponding to an amount of transaction to the bank account corresponding to the payer and the payee. A contract is created in the blockchain corresponding to the transaction including the amount of transaction and details of payer and payee. Then, the digital currency payment transfer 211 is configured for debiting the amount from the credit account of the payer for performing the transaction. Then, the amount is converted to a digital currency, corresponding to its value. The digital currency is transferred from the user profile of the payer to the user profile of the payee.

In an embodiment, the fiat payment transfer 210 and digital currency payment transfer 211 are configured for generating a bill corresponding to the amount to be debited from the credit account based on parameters set by the payer. In an embodiment, the parameters include but not limited timeline for making the payment. The amount presented in the bill is deducted from the debit account linked to the credit account of the payer based on the parameters. In an embodiment, the amount present in the bill is configured to be blocked in the debit account on availability of balance in the debit account.

In an embodiment, the digital currency is converted to the fiat currency corresponding to the amount and transferred in the account of the user profile of the payee.

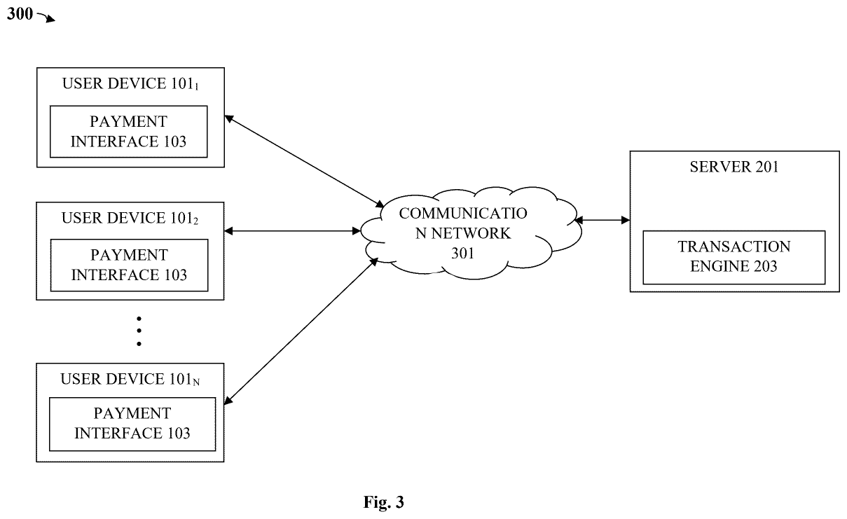

FIG. 3 illustrates a system of performing a transaction through a credit account using blockchain. In an embodiment, the system includes a plurality of user devices 101, a server 201 and a communication network 301.

In an embodiment, the plurality of user devices 101 is connected to the transaction engine 203 of the server 201 through the communication network 301. In an embodiment, the communication network 301 can include but not limited to internet.

In an embodiment, the user device 101 can include but not limited to a mobile phone, laptop, and any electronic communication device.

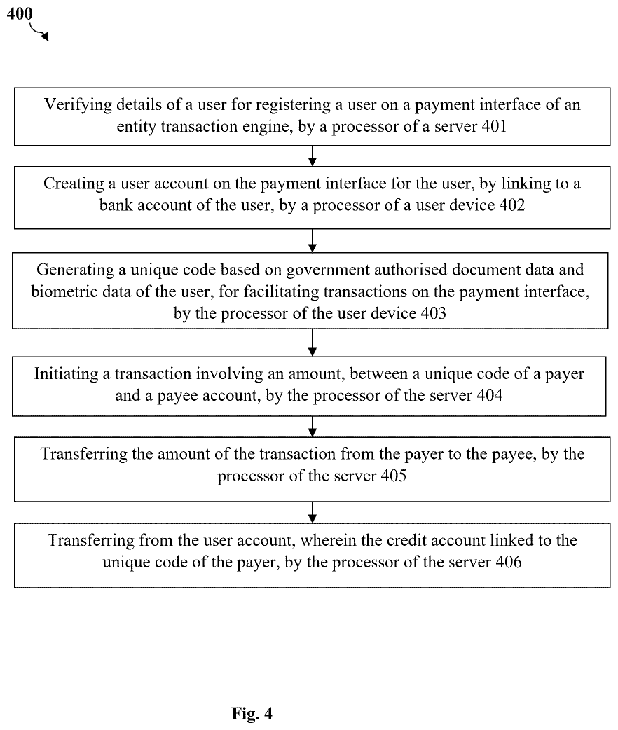

FIG. 4 illustrates a method of performing a transaction through a credit account using blockchain. In an embodiment, the method includes but not limited to the following steps. First, verifying 401 details of a user for registering a user profile on a payment interface, by a processor of a server. Next, creating a credit account on the payment interface for the user profile, by linking to a debit account of the user, by a processor of a user device.

Then, generating a unique code linked to blockchain corresponding to the user profile based on government authorised document data and biometrics data of the user, for facilitating transactions on the payment interface, by the processor of the user device. Next, initiating a transaction from the user profile, between a unique code of a payer and a unique code of a payee, by the processor of the server 404. Initiating the transaction includes generating a contract for the transaction including the amount and details of payer and payee and transmitting the contract to the payer and the payee. Based on the contract, a notification is transmitted to the debit accounts linked to the payer and payee corresponding to the transaction. Then, transferring the amount of the transaction from the payer to the payee, wherein the amount is transferred 406 from the credit account of the payer in the payee country, wherein the credit account linked to the unique code of the payer, by the processor of the server.

In another embodiment, transferring the amount includes converting the amount to a digital currency and transferring to the unique code of the payee through Blockchain, based on requirement of the user (payer/payee).

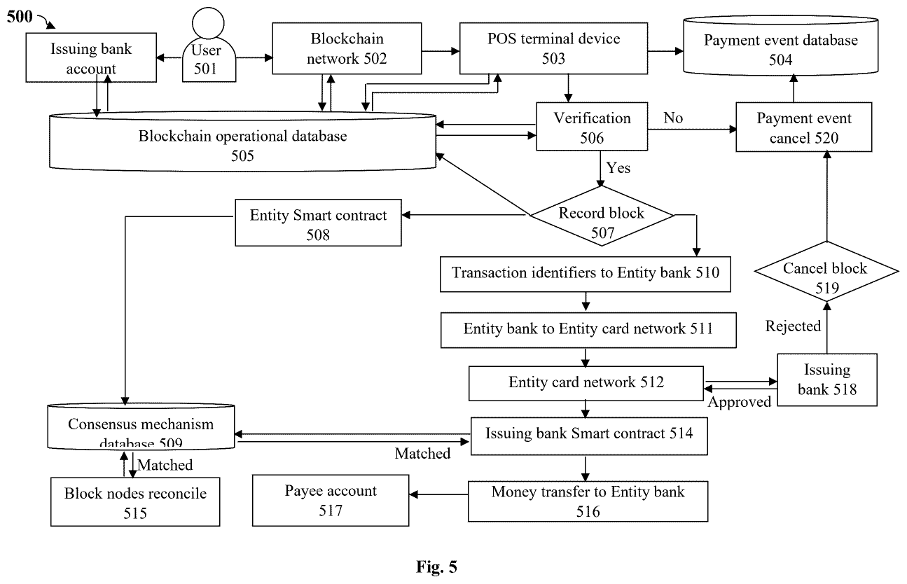

FIG. 5 illustrates a flowchart of performing a transaction on blockchain, according to an exemplary embodiment. In an embodiment, a user 501 accesses the payment interface 103 of the entity transaction engine 203 using the user device 101. The entity transaction engine 203 connects the user device 101 to the blockchain network 502. In an embodiment, the user 501 is a registered user of the entity transaction engine 203. User data including bank account associated an issuing bank, unique code, and contact data including one or a combination of mobile number, address, email-id are stored in a blockchain operational database 505 of the entity transaction engine 203. The user 501 transmits authentication data for accessing the entity transaction engine 203 through the payment interface 103 on the user device 101. The entity transaction engine 203 verifies authentication data transmitted by the user by comparing with the user data stored in the blockchain operational database 505.

A point-of-sale (POS) terminal device 503 is registered in the entity transaction engine 203. The blockchain operational database 505 stores an identity (ID) of the POS terminal device 503, and a payee account associated with the POS terminal device 503. The POS device 503 can include authentication through biometric means including but not limited to a face scanner.

In an embodiment, after verification the user 501 can access the entity transaction engine 203. The user 501 can initiate a transaction to a payee account through the unique code by performing authentication through the POS terminal device 503. The authentication can include performing face scanning and or any other biometric verification through the face scanner and/or any other biometric verification means of the POS terminal device 503.

A payment event database 504 is connected to the POS terminal device 503 for storing identifiers of the transaction including the unique code, the bank account, the payee account, and the amount.

In an embodiment, a verification 506 is performed in the entity transaction engine 203 for verifying the face scanning corresponding to the user based on user data stored in the blockchain operational database 505. The verification 506 is performed by connecting to the blockchain operational database 505.

In an embodiment, on rejection of verification 506 of the authentication, payment event is cancelled 518.

In an embodiment, on approval of verification 506 of the authentication, a block 507 is recorded in the blockchain network of the entity transaction engine 203. Simultaneously, the entity transaction engine 203 generates a first smart contract 508 based on the identifiers of the transaction including the requested amount, transaction ID, and POS ID to be transmitted to an entity bank associated with the user. The amount, transaction ID, and POS ID are transmitted to the entity bank 510. The blockchain network connects to a processor output channel of the entity bank for transmitting the identifiers of the transaction. The blockchain network then connects 511 to the entity bank output channel for transmitting the transaction identifiers to an entity card network associated with the unique code. The entity card network constitutes a network in the blockchain network, wherein the entity card network is connected to the entity bank for facilitating transactions of the unique code with their corresponding entity bank. The entity card network 511 connects to issuing bank associated with the bank account of the user through an issue processor API. The entity card network transmits the identifiers of the transaction for approval from the issuing bank. On approval, the entity transaction engine 203 generates a second SmartContract 513 based on the identifiers transmitted to the issuing bank 512. The identifiers can include the amount, the date, the transaction ID, the user, and the unique code. A consensus mechanism database 509 verifies the transaction by comparing the identifiers of the transaction in the first SmartContract associated with the entity bank and the identifiers of the transaction in the second SmartContract associated with the issuing bank. On matching the identifiers in the first SmartContract and the second SmartContract, the second smart contract 514 facilitates connection to the issuing bank through the issuing bank output channel for transmitting the amount from the issuing bank to the entity bank. Then, the amount is transmitted 516 from the entity bank to the payee account 517. Simultaneously, the consensus database mechanism 509 creates a block nodes reconcile 515 in the blockchain network for performing immediate reconciliation of the amount associated with the transaction of the user.

In an embodiment, on rejection of verification of the transaction by the issuing bank, the block chain network creates a cancel block 519 for ending the transaction. The transaction is cancelled 520 and stored in the payment event database 504.

In a preferred embodiment, the method of performing a transaction using blockchain can include the following steps. First, registering a user in an entity transaction engine on a blockchain network on verifying user data received from a user device, by a server. The registration can include linking a bank account in an issuing bank to an entity bank on the blockchain network, by the server, generating a unique code combining the user data and the bank account, by a processor of a user device, and storing the unique code corresponding to the user in a database on the blockchain network, by the server. Then, initiating a request for transaction for transferring an amount from the bank account to a payee account using the unique code, by the processor of the user device. Finally, connecting to the bank account through the unique code for transferring the amount to the payee account through the blockchain network, by the server.

In an embodiment, transferring the amount can include verifying identifiers of the transaction including the unique code, amount, bank account and payee account, by the server using the blockchain database, recording the transaction on a block on the blockchain network after verification, by the server, generating a first SmartContract defined using one or more identifiers of the transaction to be transmitted to the entity bank, by the server, connecting to a issuing bank associated with the bank account of the user based on the identifiers of the transaction, by the processor of the user device and POS terminal device, generating a second SmartContract defined using the one or more identifiers of the transaction transmitted to the issuing bank, by the server, verifying the transaction by comparing the first SmartContract and the second SmartContract for matching the identifiers by a consensus mechanism, and transmitting the amount received from the issuing bank to the payee account for performing the transaction.

In an embodiment, the bank account can include but not limited to a credit account and/or debit account in the issuing bank.

In an embodiment, the user data can include but not limited to user name, bank account of the user, government authorized documents and contact data including phone number, email Id, address. The verifying of the user data can include connecting to an external application through API for verifying the government authorized documents and the bank account provided in the user data corresponding to the user.

In an embodiment, the method can further include the steps of registering a point-of-sale terminal device to the entity transaction engine, wherein the registering includes storing the point-of-sale terminal device parameters including a payee account and an ID associated with the point-of-sale device on the entity transaction engine. Then, receiving the unique code from the user device for performing the transaction to the payee account, and connecting to the entity transaction engine for transferring the amount from the bank account to the payee account.

In an embodiment, the point-of-sale terminal device can include a face scanner for verifying the user to initiate the transaction, and the face scanning data stored in the user data in the entity transaction engine received from the user device during the registration.

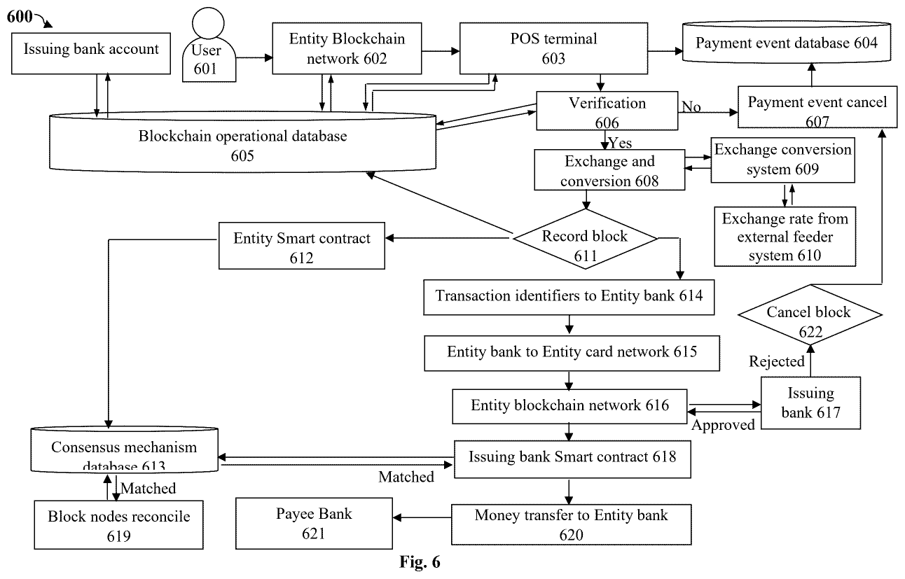

FIG. 6 illustrates a flowchart of performing a cross-currency transaction on blockchain, according to an exemplary embodiment. In an embodiment, a user 601 accesses the payment interface 103 of the entity transaction engine 203 using the user device 101. The entity transaction engine 203 connects the user device 101 to the blockchain network 502. In an embodiment, the user 601 is a registered user of the entity transaction engine 203. User data including the bank account,, unique code, and contact data including one or a combination of mobile number, address, email-id are stored in a blockchain operational database 605 of the entity transaction engine 203. The user 601 transmits authentication data for accessing the entity transaction engine 203 through the payment interface 103 on the user device 101. The entity transaction engine 203 verifies authentication data transmitted by the user by comparing with the user data stored in the blockchain operational database 605.

A point-of-sale (POS) terminal device 603 is registered in the entity transaction engine 203. The blockchain operational database 605 stores an identity (ID) of the POS terminal device 603, and a payee account associated with the POS terminal device 603. The POS device 603 can include but not limited to a face scanner.

In an embodiment, after verification, the user 601 can access the entity transaction engine 203. The user 501 can initiate a transaction to a payee account through the unique code by performing authentication through the POS terminal device 603. The authentication can include performing face scanning through the face scanner of the POS terminal device 603.

A payment event database 604 is connected to the POS terminal device 503 for storing identifiers of the transaction including the unique code, the bank account, the payee account, and the amount.

In an embodiment, a verification 606 is performed in the entity transaction engine 203 for verifying the face scanning corresponding to the user based on user data stored in the blockchain operational database 605. The verification 606 is performed by connecting to the blockchain operational database 605.

In an embodiment, on rejection of verification 606 of the authentication, payment event is cancelled 607.

In an embodiment, on approval of verification 506 of the authentication, an exchange and conversion unit in the entity transaction engine 203 performs exchange conversion 609 of the first currency to a second currency based on an exchange rate between the first currency and the second currency at that instant received from an exchange rate from external feeder system. In an embodiment, the second currency can include but not limited to a fiat currency, digital currency.

After the conversion, a block 611 is recorded in the blockchain network of the entity transaction engine 203 including the identifiers of the transaction. Simultaneously, the entity transaction engine 203 generates a first smart contract 612 based on the identifiers of the transaction including the requested amount in first currency, converted amount in second currency, transaction ID, and POS ID to be transmitted to an entity bank associated with the user. The amount, transaction ID, and POS ID are transmitted to the entity bank 614. The blockchain network connects to a processor output channel of the entity bank for transmitting the identifiers of the transaction. The blockchain network then connects 615 to the entity bank output channel for transmitting the transaction identifiers to an entity card network associated with the unique code. The entity card network constitutes a network in the blockchain network, wherein the entity card network is connected to the entity bank for facilitating transactions of the unique code with their corresponding entity bank. The entity card network 616 connects to issuing bank associated with the bank account of the user through an issue processor API. The entity card network transmits the identifiers of the transaction for approval from the issuing bank. On approval, the entity transaction engine 203 generates a second SmartContract 618 based on the identifiers transmitted to the issuing bank 512. The identifiers can include the amount in the first currency, converted amount in the second currency, the date, the transaction ID, the user, and the unique code. A consensus mechanism database 613 verifies the transaction by comparing the identifiers of the transaction in the first SmartContract associated with the entity bank and the identifiers of the transaction in the second SmartContract associated with the issuing bank. On matching the identifiers in the first SmartContract and the second SmartContract, the second smart contract 618 facilitates connection to the issuing bank through the issuing bank output channel for transmitting the amount from the issuing bank to the entity bank. Then, the converted amount in the second currency is transmitted 620 from the bank account in the entity bank through the blockchain network to the payee account 621. Simultaneously, the consensus database mechanism 613 creates a block nodes reconcile 619 in the blockchain network for performing immediate reconciliation of the amount associated with the transaction of the user.

In an embodiment, on rejection of verification of the transaction by the issuing bank, the block chain network creates a cancel block 622 for ending the transaction.

The methods according to the above-described example embodiments of the inventive concept may be implemented with program instructions which may be executed by computer or processor and may be recorded in computer-readable media. The media may also include, alone or in combination with the program instructions, data files, data structures, and the like. The program instructions recorded in the media may be designed and configured especially for the example embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to execute one or more software modules to perform the operations of the above-described example embodiments of the inventive concept, or vice versa.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

A main advantage of the present disclosure is that the system and method facilitates performing a transaction through a credit account using blockchain.

Another advantage of the present disclosure is that the system and method facilitates performing a cross-currency and cross-country transaction through a credit account using blockchain instantly.

Still another advantage of the present disclosure is that the system and method facilitates a cost-effective and secured transaction credit account-based transaction using blockchain between different entities.

Yet another advantage of the present disclosure is that the system and method facilitates a card-less and instant transaction using credit accounts between different entities through blockchain.

Still another advantage of the present disclosure is that the system and method facilitates a credit account-based transaction using blockchain eliminating swipe charges.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

I claim:

1. A method of performing a transaction using blockchain, comprising the steps of:
registering a user in an entity transaction engine on a blockchain network on verifying user data received from a user device, by a server;
wherein the registering including:
linking a bank account in an issuing bank of the user to an entity bank on the blockchain network, by the server;
generating a unique code combining the user data and the bank account, by a processor of a user device; and
storing the unique code corresponding to the user in a database on the blockchain network, by the server;
initiating a request for transaction for transferring an amount from the bank account to a payee account using the unique code, by the processor of the user device; and
connecting to the bank account through the unique code for transferring the amount to the payee account through the blockchain network, by the server.

2. The method as claimed in claim 1, wherein transferring the amount including:
verifying identifiers of the transaction including the unique code, amount, bank account and payee account, by the server using the blockchain database;
recording the transaction on a block on the blockchain network after verification, by the server;
generating a first SmartContract defined using one or more identifiers of the transaction to be transmitted to the entity bank, by the server;
connecting to a issuing bank associated with the bank account of the user based on the identifiers of the transaction, by the entity transaction engine;
generating a second SmartContract defined using the one or more identifiers of the transaction transmitted to the issuing bank, by the server;
verifying the transaction by comparing the first SmartContract and the second SmartContract for matching the identifiers by a consensus mechanism; and
transmitting the amount received from the issuing bank to the payee account for performing the transaction.

3. The method as claimed in claim 1, wherein the bank account of the user is a credit account in the issuing bank.

4. The method as claimed in claim 1, wherein the user data including user name, bank account of the user, government authorized documents and contact data including phone number, email Id, address; and
wherein the verifying including connecting to an external application through API for verifying the government authorized documents and the bank account provided in the user data corresponding to the user.

5. The method as claimed in claim 1, including:
registering a point-of-sale terminal device to the entity transaction engine (203), wherein the registering including:
storing the point-of-sale terminal device parameters including a payee account and an ID associated with the point-of-sale device on the entity transaction engine;
receiving the unique code from the user for performing the transaction to the payee account; and
connecting to the entity transaction engine for transferring the amount from the bank account to the payee account.

6. The method as claimed in claim 1, wherein the point-of-sale terminal device including a face scanner for verifying the user to initiate the transaction, and
wherein the face scanning data stored in the user data in the entity transaction engine received from the user during the registration.

7. A system for performing a transaction on a blockchain, comprising:
a server (201) including a processor (221) and a memory (219);
wherein the processor of the server configured to:
connect to a blockchain network of an entity transaction engine,
link a bank account of the user to an entity bank on the entity transaction engine based on the request of registration of the user, and
generate a unique code for the user based on user data and the bank account for performing the transaction to the payee account through the entity transaction engine.

8. The system as claimed in claim 7, including a user device (101) including a processor (113) and a memory (111);
wherein the user device (101) connected to the server (201) through a communication network (301);
wherein the processor (113) of the user device (101) configured to:
transmit the user data to the server (201) through a payment interface (103) to initiate a request for registration of a user, and
initiate a transaction of an amount to the payee account through the payment interface (103).

9. The system as claimed in claim 7, wherein a point-of-sale terminal device connected to the entity transaction engine (203),
wherein the point-of-sale device registered with a payee account, and
wherein the point of sale terminal device connecting to the entity transaction engine (203) on receiving the unique code from the user device (101), for transferring the amount from the bank account to the payee account.

10. The system as claimed in claim 7, wherein the processor of the server configured to:
connect to the bank account associated with the unique code through the processor of the server,
record a block of the transaction on the blockchain network of the entity transaction engine on verification of identifiers of the transaction,
generate a first SmartContract on the blockchain network based on the identifiers of the transaction to be transmitted to an entity bank,
generate a second SmartContract on the blockchain network based on the identifiers of the transaction transmitted to an issuing bank associated with a bank account of the user, and
verify the transaction based on the first SmartContract and the second SmartContract by a consensus mechanism on the blockchain network for performing the transaction between the bank account and the payee account.
